(19) United States
(12) Patent Application Publication
(10) Pub. No.: US 2009/0230918 A1
(43) Pub. Date: Sep. 17, 2009

(54) WIRELESS SIGNAL PROCESSING CIRCUIT UTILIZING CHARGING MODULE AS CHARGER AND ANTENNA VIA SINGLE CONNECTING PORT

(76) Inventor: Sung-Ta Tsai, Yilan County (TW)

Correspondence Address: NORTH AMERICA INTELLECTUAL PROPERTY CORPORATION, P.O. BOX 506, MERRIFIELD, VA, 22116, US

(21) Appl. No.: 12/122,740

(22) Filed: May 19, 2008

(30) Foreign Application Priority Data
Mar. 12, 2008 (TW) 097204206

(51) Int. Cl. H02J 7/00

(52) U.S. Cl. 320/107

(57) ABSTRACT

A wireless signal processing circuit includes a processing module and an inductor, wherein the processing module is utilized to process a wireless signal that is transmitted or received via a connecting port of the processing module. The inductor is coupled to the connecting port and the processing module. A charger is also coupled to the connecting port in order to draw power from an external power supply to the processing module via the connecting port, and is utilized as an antenna to receive or transmit the wireless signal.

### BACKGROUND OF THE INVENTION

1. Field of the Invention

The present invention relates to a wireless signal processing circuit, and more particularly, to a wireless signal processing circuit that utilizes a single connecting port and a charger electrically coupled to the connecting port to perform charging and antenna transmission.

2. Description of the Prior Art

As well as planning a shortest route that connects a starting point and destination point, smart navigation systems can also collect and analyze the latest traffic information, which is then combined with graphic data in a data base to provide a route that avoids delays and traffic jams. The utilization efficiency of vehicles and roads is therefore improved. The above function is achieved with the help of the Traffic Message Channel (TMC), which is a frequency modulation (FM) system that broadcasts in-time traffic and weather information by embedding digital codes in FM signals. Provided a navigation system is equipped with a TMC decoding chip, in-time road situations and related information can be extracted from the received FM signal.

Conventionally, as shown in FIG. 1, a print circuit board of a navigation device has an antenna port 110 and a charge port 120 for connecting to an external antenna 115 and an external charger 125 respectively. A TMC chip 100 obtains stable power from the charger 125 via the charge port 100, and receives the FM signal of the Traffic Message Channel from the antenna 115 via the antenna port 110. The navigation device generally uses an earphone jack to serve as the antenna port 110, or has a separate earphone jack for the antenna. Therefore, the antenna 115 needs to comply with the earphone standard of the navigation device.

### SUMMARY OF THE INVENTION

Since a conventional navigation device requires an antenna and a charger to receive signals and charges respectively, the antenna and the charger necessitate additional expenses. In order to reduce cost and increase utilization convenience, one objective of the present invention is to provide a wireless signal processing circuit that can perform charging and antenna transmission by one charger. When the wireless signal processing circuit is implemented in a TMC chip, the TMC chip does not require the external antenna, but utilizes the charger to provide both an antenna function and a power supply.

According to one exemplary embodiment of the invention, a wireless signal processing circuit is provided. The wireless signal processing circuit includes a processing module and an inductor. The processing module is for processing a wireless signal, and includes a connecting port to transmit or receive the wireless signal. The inductor is coupled to the connecting port and the processing module. When the connecting port is coupled to a charging module, the charging module draws power from an external power supply via the connecting port to the processing module, and serves as an antenna to receive or transmit the wireless signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional print circuit board of a navigation system equipped with a TMC chip.

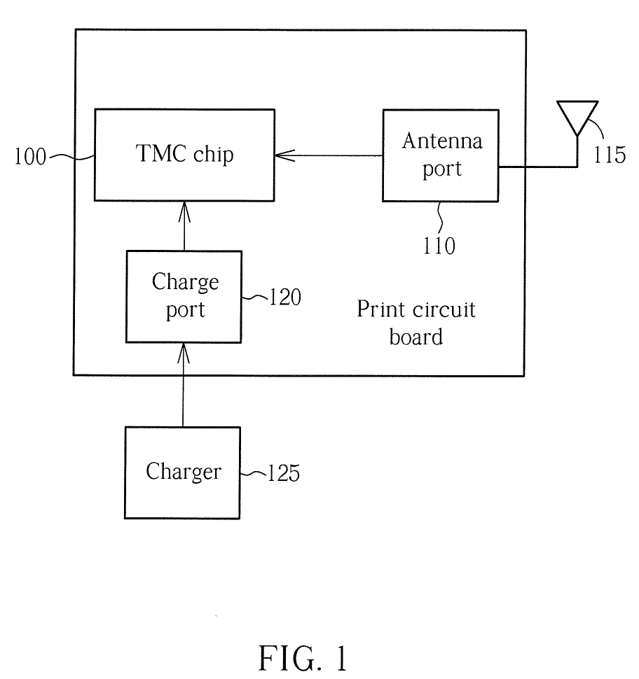

FIG. 2 shows a block diagram of a wireless signal processing circuit according to an exemplary embodiment of the present invention.

FIG. 3 shows a connection relationship between the charger, the connecting port and an external power supply when the charger is a car charger.

### DETAILED DESCRIPTION

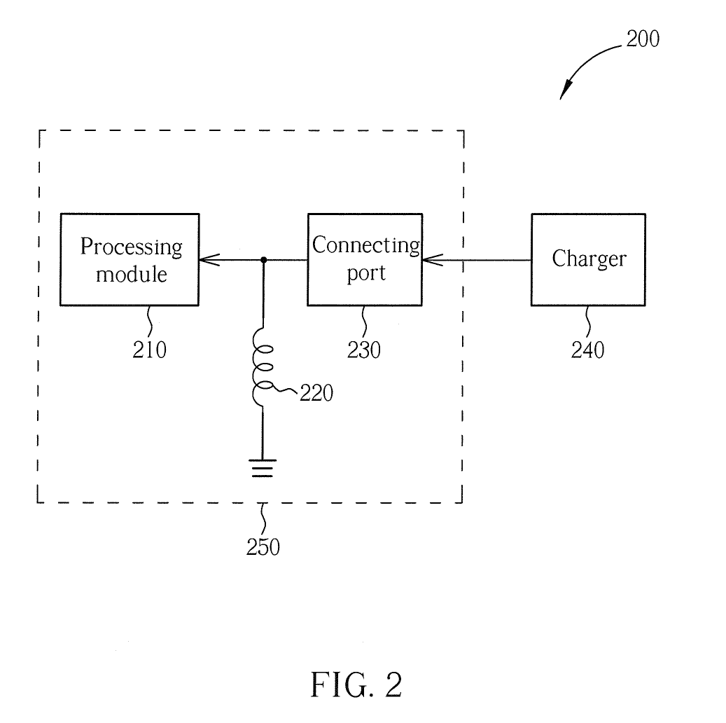

Please refer to FIG. 2, which is a diagram of a wireless signal processing circuit 200 according to an exemplary embodiment of the present invention. The wireless signal processing circuit 200 includes a processing module 210, an inductor 220 and a connecting port 230. The processing module 210 is utilized to process a wireless signal that is received or transmitted via the connecting port 230. In addition, the processing module 210 receives power from an external power supply by a charger 240 via the connecting port 230.

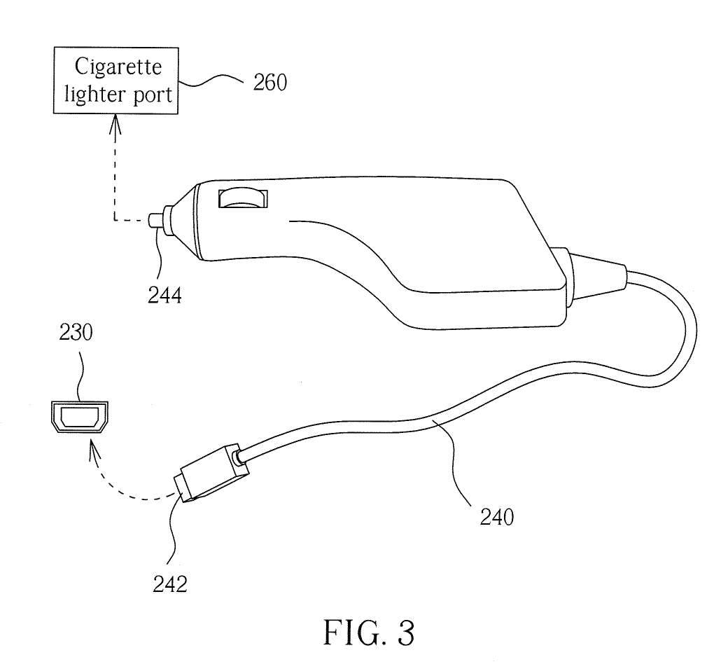

The connecting port 230 complies with one of the conventional standards, such as USB, IEEE 1394, RS-232, SCSI, EPP, ECP and LPT. One output terminal of the charger 240 complies with the connecting port 230 so as to be electrically coupled to the connecting port 230. In one embodiment, as shown in FIG. 3, the charger 240 can be a car charger having a USB output plug 242, which is used to connect to the connecting port 230. The charger 240 further has an input plug 244 that is used to connect to a cigarette lighter port 260 in car. Therefore, through the connecting port 230, the power drawn by the charger 240 is provided to the processing module 210. Moreover, the charger 240 plugged in the connecting port 230 can be utilized as an antenna: the processing module 210 sends the processed wireless signal through the connecting port 230 to the charger 240 to be transmitted, or receives a wireless signal received by the charger 240 through the connecting port 230.

The main functionalities of the inductor 220 are filtering and rating current. That is, the wireless signal processing circuit 200 selects a properly rated current inductor to perform charging, and selects a proper inductance to control the received frequency band. In general, when the charger 240 is a car charger having an output current equal to 1 A, the rated current of the inductor 220 must not be less than 1 A, otherwise the inductor 220 may be burned out during charging. Please note that the rated current and the inductance of the inductor 220 can be different depending on the system requirements.

In one embodiment, the wireless signal processing circuit 200 is implemented in a navigation system, and the processing module 210 is a TMC chip that receives an FM signal, decodes the traffic message from the FM signal, and provides the traffic message to the other processing circuits in the navigation device in order to provide an in-time road situation to the user. The inductance of the inductor 220 is selected according to the frequency band used by the traffic message channel. The inductor 220 can be disposed outside the TMC chip or be integrated within the TMC chip. In one embodiment, the processing module 210, the inductor 220 and the connecting port 230 are all disposed inside a housing 250 of the navigation device, while the charger 240 is outside the housing 250. Compared to the prior art, the navigation device in this embodiment can be charged and receive FM signals by connecting to the charger 240 only. Because the TMC broadcast is implemented by embedding digital codes in FM signals, i.e. the TMC chip 210 can provide TMC functionality after the digital codes are received and decoded, and the message quality is good enough for the TMC chip 210 by using the charger 240 as an antenna.

The present invention couples the inductor 220 to the connecting port 230, and performs charging and signal receiving/transmitting through the same connecting port 230. The antenna is no longer required, unlike in the prior art, and the charger 240 can replace the antenna directly, thereby significantly saving the cost and improving the utilization convenience.

Those skilled in the art will readily observe that numerous modifications and alterations of the device and method may be made while retaining the teachings of the invention.

What is claimed is:

1. A wireless signal processing circuit, comprising:
a processing module comprising a connecting port, for processing a wireless signal, transmitting or receiving the wireless signal though the connecting port, and receiving power through the connecting port; and
an inductor, coupled to the connecting port and the processing module.

2. The wireless signal processing circuit of claim 1, further comprising:
a charging module, coupled to the connecting port, for drawing power from an external power supply, providing power to the processing module through the connecting port, and serving as an antenna to receive or transmit the wireless signal.

3. The wireless signal processing circuit of claim 1, wherein the processing module is a traffic message control chip, for receiving and processing traffic messages.

4. The wireless signal processing circuit of claim 1, wherein the processing module is a traffic message control module, for receiving and processing traffic messages, and the traffic message control module and the inductor are disposed in a traffic message control chip.

5. The wireless signal processing circuit of claim 1, wherein the connecting port complies with one of the USB, IEEE 1394, RS-232, SCSI, EPP, ECP and LPT standards.

6. The wireless signal processing circuit of claim 2, wherein the processing module is disposed in a housing, and the charging module is disposed outside the housing.

7. The wireless signal processing circuit of claim 6, wherein the charging module is a car charger.

8. The wireless signal processing circuit of claim 7, wherein a rated current of the inductor corresponds to an output current of the car charger.

9. The wireless signal processing circuit of claim 8, wherein the rated current of the inductor is not less than the output current of the car charger.

10. The wireless signal processing circuit of claim 2, wherein a rated current of the inductor corresponds to an output current of the charging module.

11. The wireless signal processing circuit of claim 10, wherein the rated current of the inductor is not less than the output current of the charging module.

12. The wireless signal processing circuit of claim 1, wherein an inductance of the inductor corresponds to a frequency band of the wireless signal.
